(19) United States
(12) Patent Application Publication
(10) Pub. No.: US 2020/0165152 A1
(43) Pub. Date: May 28, 2020

(54) MOLD AND METHOD FOR PROCESSING GLASS

(71) Applicant: AAC Acoustic Technologies (Shenzhen) Co., Ltd., Shenzhen (CN)

(72) Inventors: Qishan Dan, Shenzhen (CN); Xudong Yan, Shenzhen (CN)

(21) Appl. No.: 16/695,092

(22) Filed: Nov. 25, 2019

(30) Foreign Application Priority Data
Nov. 27, 2018 (CN) 201811422742.8

(51) Int. Cl. C03B 23/03

(52) U.S. Cl. CPC C03B 23/0302; C03B 2215/03

(57) ABSTRACT

A mold for processing glass and a method for processing glass are disclosed. The mold is used for processing glass for processing a planar glass structure into a three-dimensional glass structure. The mold includes a lower mold part and an upper mold part. The lower mold part is made of material having a thermal expansion coefficient of approximately 5×10⁻⁶K˜approximately 7.58×10⁻⁶K. The upper mold part is made of material having a thermal expansion coefficient of approximately 8×10⁻⁶K˜approximately 28×10⁻⁶K. The upper mold part is capable of engaging with or separating from the lower mold part. When the upper mold part is engaged with the lower mold part, the upper mold part is engaged with the lower mold part cooperatively define a molding space for molding the three-dimensional glass structure.

### CROSS REFERENCE TO RELATED APPLICATIONS

This application claims priority to Chinese Patent Application No. 201811422742.8, filed on Nov. 27, 2018, the contents of which are herein incorporated by reference in their entireties.

### TECHNICAL FIELD

The present disclosure relates to the technical field of glass forming, and in particular, to a mold for processing glass and a method for processing glass.

### BACKGROUND

With the development of the Internet era, electronic devices (such as mobile phones, tablets, notebooks, and the like) have been increasingly popular with people. In addition to the functional requirements, users have higher and higher requirements for the appearance of the electronic devices, and more and more housings of the electronic devices use three-dimensional glass products.

However, in the related art, the three-dimensional glass products are easily cracked, and the yield of the three-dimensional glass products is low. Besides, it is difficult to take out the three-dimensional glass products from molds for processing the glass.

### BRIEF DESCRIPTION OF THE DRAWINGS

In order to describe the technical solutions in embodiments of the present disclosure more clearly, the following briefly introduces the accompanying drawings required for describing the embodiments. Apparently, the accompanying drawings in the following description are merely some embodiments of the present disclosure. For those skilled in the art, other drawings can be obtained based on these drawings without creative efforts.

FIG. 1 is a perspective view of a mold for processing glass according to some embodiments of the present disclosure.

FIG. 2 is an exploded view of the mold for processing glass according to some embodiments of the present disclosure.

FIG. 3 is a cross-sectional view of the mold for processing glass according to some embodiments of the present disclosure, wherein an upper mold part is separated from a lower mold part.

FIG. 4 is a cross-sectional view of the mold for processing glass according to some embodiments of the present disclosure, wherein the upper mold part is clamped with the lower mold part.

FIG. 5 is a flow chart of a method for processing glass according to some embodiments of the present disclosure.

FIG. 6 is a schematic view showing a state of the block S2 of the method shown in FIG. 5 according to some embodiments of the present disclosure.

FIG. 7 is a schematic view showing a state of the block S3 of the method shown in FIG. 5 according to some embodiments of the present disclosure.

FIG. 8 is a schematic view showing a structure of a glass product processed from a planar glass by using the mold according to some embodiments of the present disclosure.

### DETAILED DESCRIPTION

The technical solutions in the embodiments of the present disclosure will be clearly and completely described in detail below with reference to the accompanying drawings in the embodiments of the present disclosure. Apparently, the embodiments described herein are only some exemplary embodiments, not all the embodiments. Based on the embodiments described in the present disclosure, one skilled in the art may acquire all other embodiments without any creative efforts. All these shall be covered within the protection scope of the present disclosure.

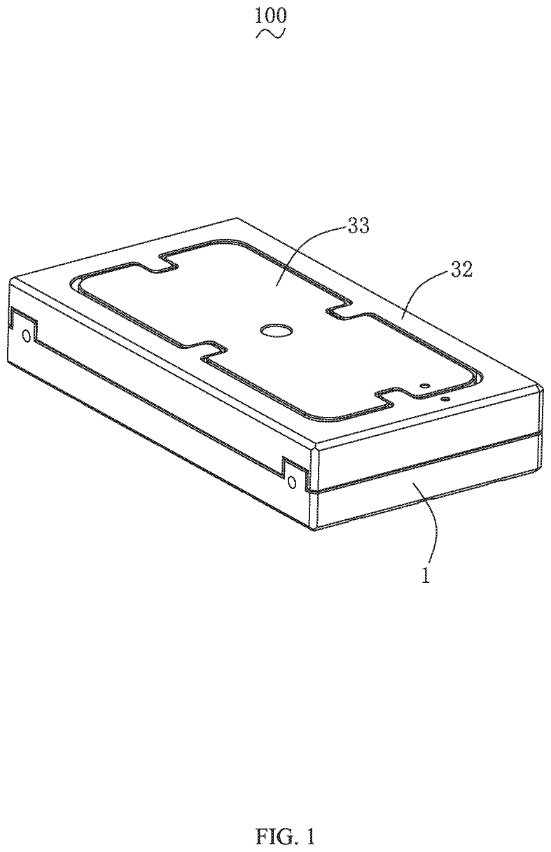

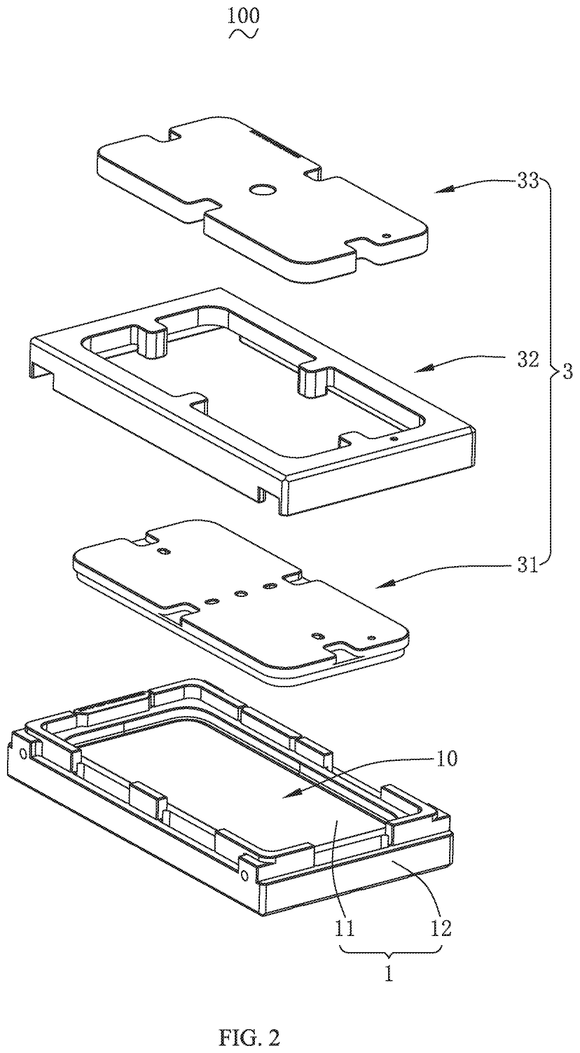

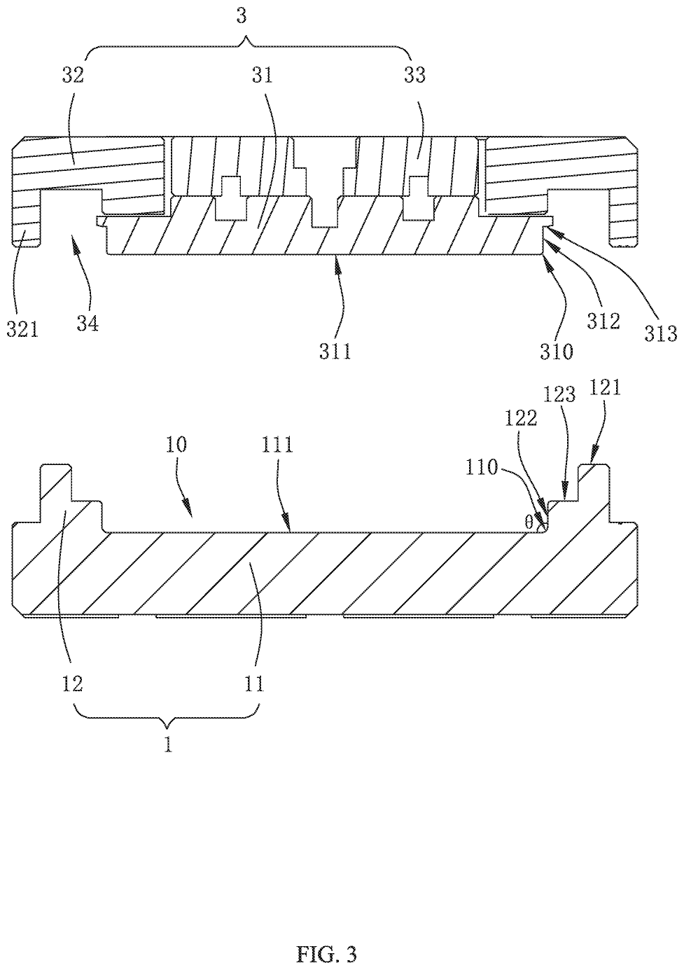

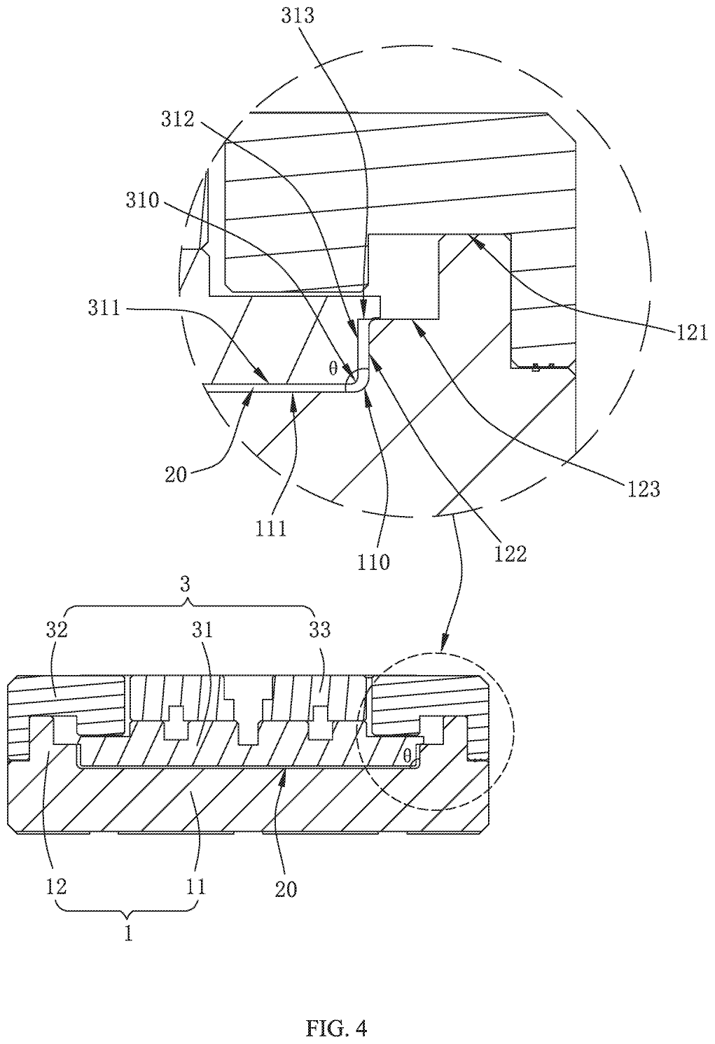

FIGS. 1-4 are schematic structural views of a mold for processing glass according to some embodiments of the present disclosure. The mold may be used for bending a planar glass structure into a three-dimensional glass structure having a receiving space. As shown in FIGS. 1-4, the mold 100 may include a lower mold part 1 and an upper mold part 3. The lower mold part 1 may define a cavity 10. The upper mold part 3 may cooperate with the lower mold part 1. More specifically, the mold 100 may have a mold-closing state in which the upper mold part 3 may be engaged/clamped with the lower mold part 1 define a molding space 20 for molding or manufacturing a three-dimensional glass structure, and may have a mold-opening state in which the upper mold part 3 may be disengaged/separated from the lower mold part 1.

In some embodiments, the lower mold part 1 may include a bottom wall 11 and a side wall 12 connected to the bottom wall 11. The side wall 12 may cooperate with the bottom wall 11 to define the cavity 10. The upper mold part 3 may include a protrusion 31. When the mold 100 is in the mold-closing state, the protrusion 31 may protrude into the cavity 10, and be spaced apart from the bottom wall 11 and the side wall 12. The protrusion 31 may cooperate with the bottom wall 11 and the side wall 12 to define the molding space 20 for molding or manufacturing the three-dimensional glass structure.

More specifically, in some embodiments, the bottom wall 11 may include an inner surface 111 located at a bottom of the cavity 10. The side wall 12 may include an upper surface 121, a first inner wall surface 122, and a second inner wall surface 123. The first inner wall surface 122 may face towards the cavity 10 and be connected to the inner surface 111. The second inner wall surface 123 may be connected to the upper surface 121 and the first inner wall surface 122. In some embodiments, the inner surface 111 may be substantially parallel to the upper surface 121, and substantially perpendicular to the first inner wall surface 122. The second inner wall surface 123 may be in shape of a step. The first inner wall surface 122 may be connected and transitioned to the inner surface 111 via a first arc 110 having a radius of approximately 0.3 mm˜approximately 1 mm.

In some embodiments, the protrusion 31 may include a top surface 311, a first side surface 312, and a second side surface 313. The top surface 311 may oppositely face towards the bottom wall 11. The first side surface 312 may extend from the top surface 311 in a direction away from (opposite to) the bottom wall 11. The second side surface 313 may extend from the first side surface 312 in a direction towards the side wall 12. Likewise, the top surface 311 may be connected and transitioned to the first side surface 312 via a second arc 310 having a radius of approximately 0.3 mm˜approximately 1 mm.

When the upper mold part 3 is clamped with the lower mold part 1, the second side surface 313 may partially abut against the second inner wall surface 123. The inner surface 111, the first inner wall surface 122, the top surface 311, the first side surface 312, and the second side surface 313 may cooperatively define the molding space 20. The molding space 20 may be configured to limit a shape of the glass substrate in a melted state to shape the glass substrate. In this way, the glass substrate may be molded into a three-dimensional glass product having a predetermined shape after being cooled. In some embodiments, an angle between the inner surface 111 and the first inner wall surface 122 may be set as θ, wherein θ satisfies: 85°≤θ≤90°.

In some embodiments of the present disclosure, the first inner wall surface 122 is connected and transitioned to the inner surface 111 via an arc, and the top surface 311 is connected and transitioned to the first side surface 312 via an arc. In this way, it is possible to reduce the possibility that the glass substrate is cracked during a hot-bending process. Besides, the three-dimensional glass product processed by the mold 100 may have a smooth overall appearance, and the aesthetic and grip of the three-dimensional glass product may be enhanced. In some embodiments, the radius of the first arc 110 may be substantially equal to the radius of the second arc 310. In some embodiments, each of the first arc 110 and the second arc 310 may have a radius of approximately 0.5 mm.

In some embodiments, the upper mold part 3 may be made of metal material having a thermal expansion coefficient of approximately 8×10⁻⁶K˜approximately 28×10⁻⁶K. The lower mold part 1 may be made of metal or graphite material having a thermal expansion coefficient of approximately 5×10⁻⁶K˜approximately 7.58×10⁻⁶K. The glass may have a thermal expansion coefficient of approximately 7.58×10⁻⁶K.

In this way, the upper mold part 3 located at an inner side of the three-dimensional glass product may have a shrinkage speed greater than that of the glass during the cooling process, thereby reducing the possibility that the three-dimensional glass product is squeezed or pressed from the inner side by the upper mold part 3 due to the too fast shrinkage speed of the glass. However, the lower mold part 1 located at an outer side of the three-dimensional glass product may have a shrinkage speed less than that of the glass during the cooling process, thereby reducing the possibility that the glass substrate is squeezed from the outer side by the lower mold part 1 due to the too fast shrinkage speed of the lower mold part 1. Therefore, the three-dimensional glass product may not be interfered with the upper mold part 3 or the lower mold part 1. The three-dimensional glass product may be easy to take out. The possibility that the three-dimensional glass product is cracked may be reduced, and the yield may be improved. When the upper mold part 3 is not clamped with the lower mold part 1, that is, when the upper mold part 3 is separated or disengaged from the lower mold part 1, the protrusion 31 of the upper mold part 3 may have a size less than a size of the inner side of the glass substrate, and the cavity 10 may have an inner size greater than that of the outer side of the glass substrate. In this way, the glass substrate may be automatically released or separated from the mold 100, and the processing processes may be simplified.

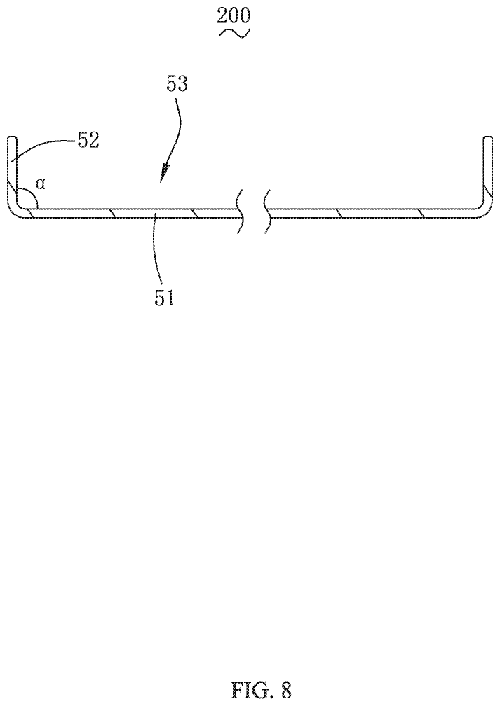

Herein, the “inner side” of the three-dimensional glass product may refer to the side facing towards to a receiving space (the receiving space as shown in FIG. 8). The “outer side” of the three-dimensional glass product may refer to the side opposite to the inner side and facing away to the receiving space.

In some embodiments, the second side surface 313 may be substantially perpendicular to the first inner wall surface 122 and the first side surface 312. In some embodiments, the first inner wall surface 122 and the first side surface 312 may be both vertical surfaces (that is, the surfaces may be substantially parallel to a direction of the mold 100 along which the upper mold part 3 is engaged or disengaged with the lower mold part 1). The second side surface 313 may be a horizontal surface (that is, the surface may be substantially perpendicular to the direction of the mold 100 along which the upper mold part 3 is engaged or disengaged with the lower mold part 1).

In some embodiments, the upper mold part 3 may further include a frame 32 configured to receive the protrusion 31. The frame 32 may include a baffle 321 protruding towards the lower mold part 1. The baffle 321 may be spaced apart from the protrusion 31 to define a groove 34. When the upper mold part 3 is engaged with the lower mold part 1, the side wall 12 of the lower mold part 1 may be engaged in the groove 34.

In some embodiments, the upper mold part 3 may further include a weighted member 33. The weighted member 33 may be configured to apply a pressure to the protrusion 31. In some embodiments, the weighted member 33 may be in shape of a block. The weighted member 33 may be located above the protrusion 31 and further received in the frame 32. In some embodiments, the upper mold part 3 may be configured in a detachable form, that is, the upper mold part 3 may include multiple detachable components. In this way, it is convenient to replace some components of the upper mold part 3 when the upper mold part 3 is damaged. In some embodiments, the protrusion 31 may be more easily damaged, and thus only a single component (the protrusion 31) needs to be replaced. In some embodiments, the protrusion 31, the frame 32, and the weighted member 33 may be made of the same material or different material. In some embodiments, the protrusion 31, the frame 32, and the weighted member 33 may be made of any metal material having a thermal expansion coefficient of approximately 8×10^{0.6} K˜approximately 28×10⁻⁶K.

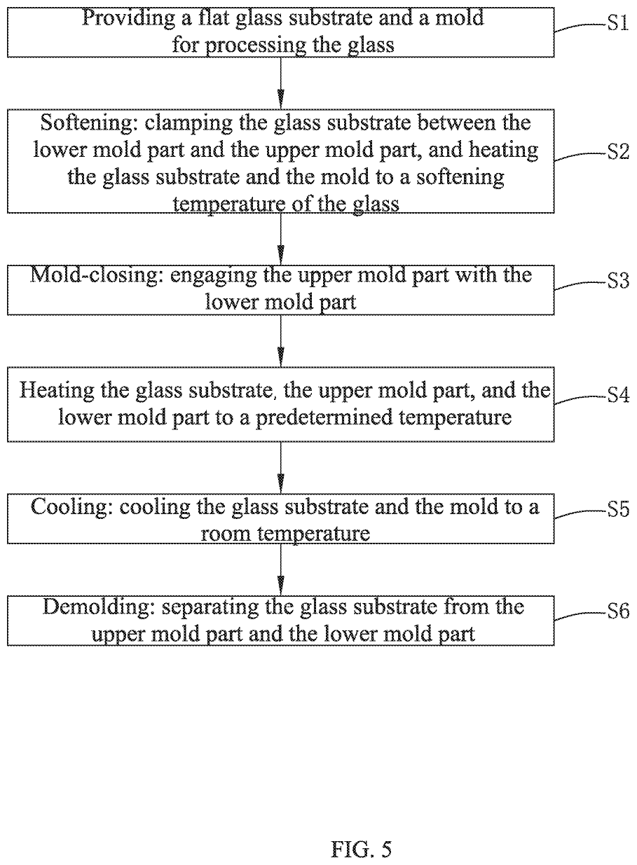

In some embodiments, a method for processing the glass may also be provided in some embodiments of the present disclosure. As shown in FIG. 5, the method may include operations executed by the following blocks.

At block S1, a planar glass substrate 200 and a mold 100 for processing the glass may be provided. The mold 100 may be the mold 100 described above.

As described above, the mold 100 may include a lower mold part 1 and an upper mold part 3. The lower mold part 1 may define a cavity 10. The upper mold part 3 may cooperate with the lower mold part 1. The upper mold part 3 may be made of metal material having a thermal expansion coefficient of approximately 8×10⁻⁶ K˜approximately 28×10⁻⁶K. The lower mold part 1 may be made of metal or graphite material having a thermal expansion coefficient of approximately 5×10⁻⁶ K˜approximately 7.58×10⁻⁶K.

At block S2, softening: the glass substrate 200 may be clamped and sandwiched between the lower mold part 1 and the upper mold part 3 of the mold 100. The glass substrate 200 and the mold 100 may be heated to a softening temperature of glass.

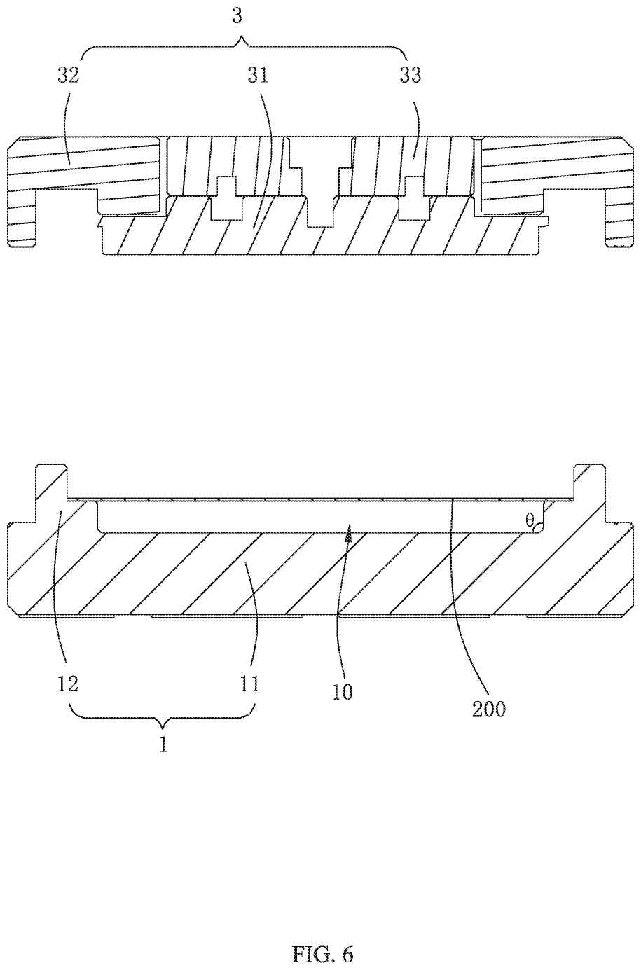

More specifically, as shown in FIG. 6, in some embodiments, a periphery of the glass substrate 200 may be clamped to the second inner wall surface 123 of the lower mold part 1. In general, the softening temperature may be equal to or greater than 700° C. In some embodiments, the softening temperature may be substantially equal to 700° C. During the heating process at the block S2, the mold 100 may be in a mold-opening state (the state in which the upper mold part 3 is separated from the lower mold part 1), and the upper mold part 3 has not yet inserted into the cavity 10. The glass substrate 200 may be clamped between the upper mold part 3 and the lower mold part 1 when the glass substrate 200 is in a hardened state, which provides a preparation for the subsequent mold-closing process.

At block S3, mold-closing: the lower mold part 1 may be clamped or engaged with the upper mold part 3, such that the mold 100 is in a mold-closing state.

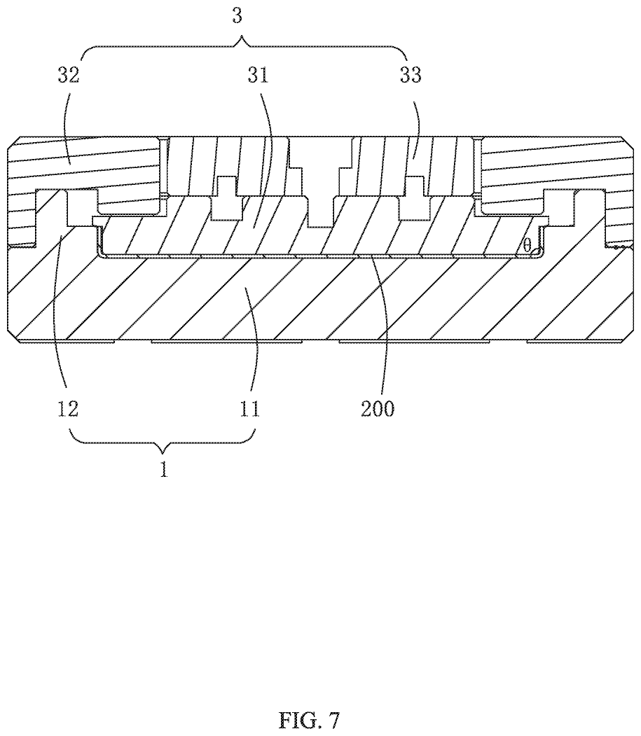

As shown in FIG. 7, during the mold-closing process, the glass substrate 200 may be in a softened state. When the upper mold part 3 is clamped or engaged with the lower mold part 1 such that the mold 100 is closed, the glass substrate 200 may be heated and bent under the mold clamping pressure. In this way, a three-dimensional glass structure may be produced by using the glass substrate 200. In some embodiments, as shown in FIG. 8, the three-dimensional glass structure may include a body portion 51 and a bending portion 52 bent from the body portion 51. The glass substrate 200 as well as the three-dimensional glass structure may be finally restricted in the molding space 20 defined by the lower mold part 1 and the upper mold part 3 when the upper mold part 3 is clamped or engaged with the lower mold part 1.

At block S4, continuously heating again: the glass substrate 200 and the mold 100 may be continuously heated to a preset temperature. In some embodiments, the preset temperature may be approximately 720° C.˜approximately 780° C.

In some embodiments, during the process of continuously heating, the upper mold part 3 may be made of metal material having a thermal expansion coefficient of approximately 8×10⁻⁶K˜approximately 28×10⁻⁶K, the lower mold part 1 may be made of metal or graphite material having a thermal expansion coefficient of approximately 5×10⁻⁶K˜approximately 7.58×10⁻⁶K, and the glass has a thermal expansion coefficient of approximately 7.58×10⁻⁶K. In this way, the upper mold part 3 may have an expansion speed greater than that of the glass, while the lower mold part 1 may have an expansion speed less than that of the glass. Therefore, the upper mold part 3 and the lower mold part 1 may give certain pressures to the glass substrate 200 from the inner side and outer side of the glass substrate 200, and thus the glass substrate 200 may be more easily to be hot-bent.

At block S5, cooling: the glass substrate 200 and the mold 100 may be cooled to a room temperature.

The cooling process may be divided into two stages. In a first stage, the glass substrate 200 may be changed from the softened state to the hardened state, during which the glass substrate 200 may be closely contact with or attached to the upper mold part 3 and the lower mold part 1. In a second stage, the glass substrate 200 may shrink according to the thermal expansion coefficient thereof. The upper mold part 3 has a thermal expansion coefficient greater than that of the glass, and thus the upper mold part 3 may shrink faster than the glass substrate 200. In this way, an outer size of the protrusion 31 of the upper mold part 3 may be reduced to be less than a size of an inner chamber of the glass substrate 200, and thus the upper mold part 3 may be separated from the glass substrate 200. However, the lower mold part 1 has a thermal expansion coefficient less than that of the glass, such that the lower mold part 1 may shrink slower than the glass substrate 200. In this way, the inner size of the cavity 10 of the lower mold part 1 may be greater than an outer size of the glass substrate 200, and thus the lower mold part 1 may be automatically separated from the glass substrate 200. Therefore, during the cooling process, the glass substrate 200 may be not subjected to a pressure from any component of the mold 100, and thus the possibility that the glass substrate 200 is cracked may be reduced. Besides, the glass substrate 200 may be automatically separated from the lower mold part 1 and the upper mold part 3 during the cooling process.

At block S6, demolding: the glass substrate 200 may be separated from the lower mold part 1 and the upper mold part 3 to complete demolding.

After the demolding, the glass substrate 200 has been formed into the three-dimensional glass structure from the planar glass structure. As shown in FIG. 8, at this time, the glass substrate 200 (that is, three-dimensional glass structure) may include the body portion 51 and the bending portion 52 bent from an edge of the body portion 51. The body portion 51 may cooperate with the bending portion 52 to define the receiving space 53 opened at one end. The bending portion 52 may be connected to the body portion 51 via an arc. In some embodiments, the body portion 51 may have a flat shape. An inner angle α between the bending portion 52 and the body portion 51 and toward the receiving space 53 may be ranged between approximately 85° and approximately 90°.

Compared with the related art, in the mold 100 according to some embodiments of the present disclosure, the upper mold part 3 may be made of metal material having a thermal expansion coefficient of approximately 8×10⁻⁶K˜approximately 28×10⁻⁶K, and the lower mold part 1 made of metal or graphite material having a thermal expansion coefficient of approximately 5×10⁻⁶K˜approximately 7.58×10⁻⁶K. By using the differences between the thermal expansion coefficients of the upper mold part 3 and the glass, and between the lower mold part 1 and the glass, it is possible to reduce the possibility that the three-dimensional glass product is interfered with the mold 100 during the cooling process. In this way, the three-dimensional glass product may be easy to take out, the possibility that the three-dimensional glass product is cracked may be reduced, and the yield may be improved. Furthermore, the three-dimensional glass product may be automatically separated from the mold, and thus the processing of the product may be simplified.

In some embodiments, the upper mold part 3 and the lower mold part 1 may have other configurations and may include any suitable component. Besides, the upper mold part 3 may also be made of other material, as long as the material has a thermal expansion coefficient of approximately 8×10⁻⁶K˜approximately 28×10⁻⁶K. Likewise, the lower mold part 1 may also be made of other material, as long as the material has a thermal expansion coefficient of approximately 5×10⁻⁶K˜approximately 7.58×10⁻⁶K.

The above may be only some embodiments of the present disclosure. It should be noted that those skilled in the art can make improvements without departing from the inventive concept of the present disclosure. All these may be covered within the protection scope of the present disclosure.

What is claimed is:

1. A mold for processing glass, the mold being configured for processing a planar glass structure into a three-dimensional glass structure, the mold comprising:
a lower mold part, defining a cavity, made of metal material or graphite material having a thermal expansion coefficient of approximately 5×10⁻⁶K˜approximately 7.58×10⁻⁶K, and comprising:
a bottom wall; and
a side wall, cooperating with the bottom wall to define the cavity; and
an upper mold part, cooperating with the lower mold part, made of metal material having a thermal expansion coefficient of approximately 8×10⁻⁶K˜approximately 28×10⁻⁶K, and comprising a protrusion;
wherein when the upper mold part is engaged with the lower mold part, the protrusion protrudes into the cavity, is spaced apart from the bottom wall and the side wall, and cooperates with the bottom wall and the side wall to define a molding space for molding the three-dimensional glass structure.

2. The mold according to claim 1, wherein the bottom wall comprises an inner surface located at a bottom of the cavity;
the side wall comprises a first inner wall surface, the first inner wall surface faces towards the cavity and is connected to the inner surface, and the first inner wall surface is connected to the inner surface via a first arc having a radius of approximately 0.3 mm˜approximately 1 mm.

3. The mold according to claim 2, wherein the protrusion comprises a top surface and a first side surface; the top surface faces towards the bottom wall, the first side surface extends from the top surface in a direction away from the bottom wall, and the top surface is connected to the first side surface via a second arc having a radius of approximately 0.3 mm˜approximately 1 mm.

4. The mold according to claim 3, wherein the radius of the first arc is substantially equal to the radius of the second arc.

5. The mold according to claim 4, wherein each of the first arc and the second arc has a radius of approximately 0.5 mm.

6. The mold according to claim 3, wherein the protrusion further comprises a second side surface, and the second side surface extends from the first side surface in a direction towards the side wall;
the second side surface is substantially perpendicular to the first inner wall surface and the first side face.

7. The mold according to claim 6, wherein the side wall further comprises a second inner wall surface, and the second inner wall surface is in shape of a step and connected to the upper surface and the first inner wall surface;
when the upper mold part is engaged with the lower mold part, the second side surface partially abuts against the second inner wall surface.

8. The mold according to claim 2, wherein an angle defined between the inner surface and the first inner wall surface is set as θ, wherein θ satisfies: 85°≤θ≤90°.

9. The mold according to claim 1, further comprising a frame for receiving the protrusion, wherein the frame comprises a baffle protruding towards the lower mold part, and the baffle is spaced apart from the protrusion, such that the baffle and the protrusion cooperatively define a groove;
when the upper mold part is engaged with the lower mold part, the side wall of the lower mold part is engaged in the groove.

10. The mold according to claim 9, wherein the upper mold part further comprises a weighted member for applying a pressure to the protrusion;
the weighted member is located above the protrusion and received in the frame.

11. A mold for processing glass for processing a planar glass structure into a three-dimensional glass structure, comprising:
a lower mold part, made of material having a thermal expansion coefficient of approximately 5×10⁻⁶K˜approximately 7.58×10⁻⁶K; and
an upper mold part, made of material having a thermal expansion coefficient of approximately 8×10⁻⁶K˜approximately 28×10⁻⁶K;
wherein the upper mold part is capable of engaging with or separating from the lower mold part; when the upper mold part is engaged with the lower mold part, the upper mold part is engaged with the lower mold part cooperatively define a molding space for molding the three-dimensional glass structure.

12. The mold according to claim 11, wherein the upper mold part comprises a bottom wall and a side wall, and the bottom wall and the side wall cooperatively define a cavity;
the upper mold part comprises a protrusion;
wherein when the upper mold part is engaged with the lower mold part, the protrusion protrudes into the cavity, is spaced apart from the bottom wall and the side wall; the protrusion, the bottom wall, and the side wall cooperatively define the molding space.

13. The mold according to claim 12, wherein the bottom wall comprises an inner surface located at a bottom of the cavity;
the side wall comprises a first inner wall surface, the first inner wall surface faces towards the cavity and is connected to the inner surface, and the first inner wall surface is connected to the inner surface via a first arc having a radius of approximately 0.3 mm˜approximately 1 mm;
the protrusion comprises a top surface and a first side surface; the top surface faces towards the bottom wall, the first side surface extends from the top surface in a direction away from the bottom wall, and the top surface is connected to the first side surface via a second arc having a radius of approximately 0.3 mm˜approximately 1 mm.

14. The mold according to claim 13, wherein the radius of the first arc is substantially equal to the radius of the second arc, and each of the first arc and the second arc has a radius of approximately 0.5 mm.

15. The mold according to claim 13, wherein the protrusion further comprises a second side surface, and the second side surface extends from the first side surface in a direction towards the side wall;
the second side surface is substantially perpendicular to the first inner wall surface and the first side face.

16. The mold according to claim 13, wherein an angle defined between the inner surface and the first inner wall surface is set as θ, wherein θ satisfies: 85°≤θ≤90°.

17. The mold according to claim 11, further comprising a frame for receiving the protrusion, wherein the frame comprises a baffle protruding towards the lower mold part, and the baffle is spaced apart from the protrusion, such that the baffle and the protrusion cooperatively define a groove; when the upper mold part is engaged with the lower mold part, the side wall of the lower mold part is engaged in the groove;
the upper mold part further comprises a weighted member for applying a pressure to the protrusion, and the weighted member is located above the protrusion and received in the frame.

18. A method for processing glass, comprising:
providing a planar glass substrate and a mold for processing the glass; wherein the mold comprises:
a lower mold part, defining a cavity, made of metal material or graphite material having a thermal expansion coefficient of approximately 5×10⁻⁶K˜approximately 7.58×10⁻⁶K, and comprising:
a bottom wall; and
a side wall, cooperating with the bottom wall to define the cavity; and
an upper mold part, cooperating with the lower mold part, made of metal material having a thermal expansion coefficient of approximately 8×10⁻⁶K˜approximately 28×10⁻⁶K, and comprising a protrusion;
wherein when the upper mold part is engaged with the lower mold part, the protrusion protrudes into the cavity, is spaced apart from the bottom wall and the side wall, and cooperates with the bottom wall and the side wall to define a molding space for molding the three-dimensional glass structure;
clamping the glass substrate between the lower mold part and the upper mold part, and heating the glass substrate and the mold to a softening temperature of the glass;
engaging the upper mold part with the lower mold part;
cooling the glass substrate and the mold to a room temperature; and
separating the glass substrate from the upper mold part and the lower mold part.

19. The method according to claim 18, wherein the cooling process comprises:
cooling the glass substrate, the upper mold part, and the lower mold part such that the glass substrate is hardened, during which the glass substrate keeps attached to the upper mold part and the lower mold part; and
cooling the glass substrate, the upper mold part, and the lower mold part to the room temperature, during which the glass substrate is automatically separated from the lower mold part and the upper mold part.

20. The method according to claim 18, after the engaging the upper mold part with the lower mold part, the method further comprising:
heating the glass substrate, the upper mold part, and the lower mold part to a predetermined temperature, wherein the predetermined temperature is approximately 720° C.˜approximately 780° C.
